(19) United States
(12) Patent Application Publication
(10) Pub. No.: US 2021/0216892 A1
(43) Pub. Date: Jul. 15, 2021

(54) DEVICE DROP DETECTION USING MACHINE LEARNING

(71) Applicant: Hand Held Products, Inc., Fort Mill, SC (US)

(72) Inventors: Manjul Bizoara, Hyderabad (IN); Neelendra Bhandari, Charlotte, NC (US); Douglas Hinson, Monroe, NC (US); Kexin Quan, Suzhou (CN); Bryan Bavaro, Point Roberts (CA); Taylor Smith, Charlotte, NC (US)

(21) Appl. No.: 17/143,548

(22) Filed: Jan. 7, 2021

(30) Foreign Application Priority Data
Jan. 10, 2020 (CN) 202010027078.8

(51) Int. Cl. G06N 5/04; G06N 20/00

(52) U.S. Cl. CPC G06N 5/04; G06N 20/00

(57) ABSTRACT

Various embodiments described herein relate to device abuse detection using machine learning. In this regard, a system compares accelerometer data of an electronic device with a plurality of defined accelerometer threshold values to identify a primary abuse event category associated with the electronic device. In response to the primary abuse event category being identified, the system generates a first prediction for a secondary abuse event category associated with the electronic device based on a machine learning technique associated with inertial data of the electronic device, image data generated by the electronic device, and audio data captured by the electronic device. Furthermore, the system transmits the inertial data, the image data and the audio data to a network server device associated with a machine learning service to facilitate generation of a second prediction for the secondary abuse event category based on the inertial data, the image data, and the audio data.

### CROSS REFERENCE TO RELATED APPLICATIONS

This application claims the benefit of Chinese Patent Application No. 202010027078.8, titled “DEVICE DROP DETECTION USING MACHINE LEARNING,” and filed Jan. 10, 2020, the contents of which are hereby incorporated herein by reference in their entirety.

### TECHNICAL FIELD

The present disclosure relates generally to machine learning, and more particularly to machine learning based abuse detection for a device.

### BACKGROUND

Electronic devices, such as enterprise mobility devices, can be subject to harsh industrial environments. However, users are generally not aware of performance specifications of an electronic device. In addition, users generally have minimal vested ownership of an enterprise mobility device, so protecting the enterprise mobility device or using the enterprise mobility device with care may not be a concern for the user. Moreover, there is currently no mechanism to track electronic device handling and/or to inform a user that mechanical specifications of the electronic device have been exceeded. Through applied effort, ingenuity, and innovation, many of these identified problems have been solved by developing solutions that are included in embodiments of the present disclosure, many examples of which are described in detail herein.

### BRIEF SUMMARY

In accordance with an embodiment of the present disclosure, a system comprising a processor and a memory is provided. The memory stores executable instructions that, when executed by the processor, cause the processor to compare accelerometer data of an electronic device with a plurality of defined accelerometer threshold values to identify a primary abuse event category associated with the electronic device. In response to the primary abuse event category being identified, the executable instructions further cause the processor to generate a first prediction for a secondary abuse event category associated with the electronic device based on a machine learning technique associated with inertial data of the electronic device, image data generated by the electronic device, and audio data captured by the electronic device. Furthermore, the executable instructions cause the processor to transmit the inertial data, the image data and the audio data to a network server device associated with a machine learning service to facilitate generation of a second prediction for the secondary abuse event category based on the inertial data, the image data, and the audio data.

In accordance with another embodiment of the present disclosure, a computer-implemented method is provided. The computer-implemented method provides for comparing, by a device comprising a processor, accelerometer data of an electronic device with a plurality of defined accelerometer threshold values to identify a primary abuse event category associated with the electronic device. In response to the primary abuse event category being identified, the computer-implemented method also provides for generating, by the device, a first prediction for a secondary abuse event category associated with the electronic device based on a machine learning technique associated with inertial data of the electronic device, image data generated by the electronic device, and audio data captured by the electronic device. Furthermore, the computer-implemented method provides for transmitting, by the device, the inertial data, the image data and the audio data to a network server device associated with a machine learning service to facilitate generating a second prediction for the secondary abuse event category based on the inertial data, the image data, and the audio data.

In accordance with yet another embodiment of the present disclosure, a computer program product is provided. The computer program product at least one computer-readable storage medium having program instructions embodied thereon, the program instructions executable by a processor to cause the processor to compare accelerometer data of an electronic device with a plurality of defined accelerometer threshold values to identify a primary abuse event category associated with the electronic device. In response to the primary abuse event category being identified, the program instructions are also executable by the processor to cause the processor to generate a first prediction for a secondary abuse event category associated with the electronic device based on a machine learning technique associated with inertial data of the electronic device, image data generated by the electronic device, and audio data captured by the electronic device. Furthermore, the program instructions are executable by the processor to cause the processor to transmit the inertial data, the image data and the audio data to a network server device associated with a machine learning service to facilitate generation of a second prediction for the secondary abuse event category based on the inertial data, the image data, and the audio data.

In accordance with yet another embodiment of the present disclosure, a system comprising a processor and a memory is provided. The memory stores executable instructions that, when executed by the processor and in response to a first prediction for an abuse event category being determined by an electronic device, cause the processor to receive inertial data of the electronic device, image data generated by the electronic device, and audio data captured by the electronic device. The executable instructions further cause the processor to generate a second prediction for the abuse event category based on a machine learning process associated with the inertial data, the image data, and the audio data. Furthermore, the executable instructions cause the processor to initiate an action associated with the electronic device based on the first prediction for the abuse event category and the second prediction for the abuse event category.

In accordance with yet another embodiment of the present disclosure, a computer-implemented method is provided. In response to a first prediction for an abuse event category being determined by an electronic device, the computer-implemented method provides for receiving, by a device comprising a processor, inertial data of the electronic device, image data generated by the electronic device, and audio data captured by the electronic device. The computer-implemented method also provides for generating, by the device, a second prediction for the abuse event category based on a machine learning process associated with the inertial data, the image data, and the audio data. Furthermore, the computer-implemented method provides for initiating, by the device, an action associated with the electronic device based on the first prediction for the abuse event category and the second prediction for the abuse event category.

In accordance with yet another embodiment of the present disclosure, a computer program product is provided. The computer program product at least one computer-readable storage medium having program instructions embodied thereon, the program instructions executable by a processor to cause the processor to, in response to a first prediction for an abuse event category being determined by an electronic device, receive inertial data of the electronic device, image data generated by the electronic device, and audio data captured by the electronic device. The program instructions are also executable by the processor to cause the processor to generate a second prediction for the abuse event category based on a machine learning process associated with the inertial data, the image data, and the audio data. Furthermore, the program instructions are executable by the processor to cause the processor to initiate an action associated with the electronic device based on the first prediction for the abuse event category and the second prediction for the abuse event category.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a device abuse detection system, in accordance with one or more embodiments described herein;

FIG. 2 illustrates a cloud machine learning system, in accordance with one or more embodiments described herein;

FIG. 3 illustrates a system associated with an exemplary environment for performing device abuse detection using machine learning, in accordance with one or more embodiments described herein;

FIG. 4 illustrates a system associated with another exemplary environment for performing device abuse detection using machine learning, in accordance with one or more embodiments described herein;

FIG. 5 illustrates a system associated with a digital signal process, in accordance with one or more embodiments described herein;

FIG. 6 illustrates a system associated with a machine learning process, in accordance with one or more embodiments described herein;

FIG. 7 illustrates a system associated with performing device abuse detection using machine learning, in accordance with one or more embodiments described herein;

FIG. 8 illustrates a system associated with accelerometer data, in accordance with one or more embodiments described herein;

FIG. 9 illustrates a flow diagram for facilitating device abuse detection using machine learning, in accordance with one or more embodiments described herein; and

FIG. 10 illustrates another flow diagram for facilitating device abuse detection using machine learning, in accordance with one or more embodiments described herein.

### DETAILED DESCRIPTION

Various embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Electronic devices (e.g., enterprise electronic devices) can be subject to harsh environments. For example, electronic devices (e.g., enterprise mobility devices) can be subject to harsh industrial environments, harsh material handling environments harsh commercial environments and/or another harsh environment related to distribution centers, shipping centers, warehouses, factories, stores, etc. However, users are generally not aware of performance specifications of an electronic device. In addition, users generally have minimal vested ownership of an enterprise electronic device, so protecting the enterprise electronic device or using the enterprise electronic device with care may not be a concern for the user. Moreover, there is currently no mechanism to track electronic device handling and/or to inform a user that mechanical specifications of the electronic device have been exceeded. Therefore, an accurate drop detection mechanism (e.g., an accurate abuse detection mechanism) for an electronic device is desirable.

The word “abuse” is used herein to mean intentional damage. For example, abuse to an electronic device can be considered intentional damage to the electronic device. Additionally, an “abuse event” as used herein can correspond to an event related to one or more actions that results in intentional damage to an electronic device.

Thus, to address these and/or other issues, novel device abuse detection using machine learning is disclosed herein. In this regard, with the novel device abuse detection using machine learning disclosed herein, performance and/or a state of health of an electronic device can be improved as compared to conventional electronic devices. Moreover, with the novel device abuse detection using machine learning disclosed herein, electronic device diagnostics and/or electronic device usage tracking can be improved. Furthermore, automatic device abuse identification to send one or more notifications and/or feedback related to an abuse event can be provided. In an embodiment, acceleration associated with an electronic device, orientation associated with the electronic device, rotational speed associated with the electronic device, temperature associated with the electronic device, inertial history associated with the electronic device and/or other data associated with the electronic device can be employed by a machine learning classifier to provide an accurate drop detector, an accurate throw detector, and/or an accurate abuse detector for the electronic device. Based on the acceleration, the orientation, the rotational speed, the temperature, the inertial history and/or the other data associated with the electronic device, the machine learning classifier can generate an abuse detection probability (e.g., an abuse detection probability score). Initial training data for the machine learning classifier can be gathered, for example, from device engineering tests, computer modeling, computer simulations, material performance models and/or another data source. Training of the machine learning classifier can be further improved over time using impact event data gathered from the field (e.g., through other electronic devices) and/or device inspections associated with other electronic devices. Accordingly, an ability can be provided to notify users when a mechanical abuse associated with an electronic device has been detected. As a result, user awareness regarding potential damage to an electronic device can be improved, future behavior of a user with respect to an electronic device can be altered and/or usability of an electronic device (e.g., device life) can be prolonged. In certain embodiments, a device health status of an electronic device can be provided. For example, snapshot logs for an electronic device can be triggered by abuse events. The snapshot logs can be employed, for example, for forensic analysis to impact characteristics including height, orientation, rotation and/or environmental conditions. The snapshot logs can additionally or alternatively be employed as learning feedback for machine learning. Furthermore, the snapshot logs can additionally or alternatively be employed to correlate device subsystem malfunctions of an electronic device to abuse events (e.g., to associate a broken display of an electronic device with a particular abuse event associated with the electronic device, etc.). In another embodiment, data associated with abuse events for an electronic device can be employed to drive predictive analytics for future abuse detections for electronic devices. In yet another embodiment, the data associated with abuse events can additionally or alternatively be employed to provide dashboard device damage alerts and/or preemptive maintenance alerts for electronic devices. In certain embodiments, the data associated with abuse events can additionally or alternatively be employed for context related to device returns and/or warranty claims for electronic devices.

In an embodiment, an abuse event for an electronic device and a corresponding category can be determined by using one or more machine learning techniques. The abuse event for the electronic device can include, for example, a primary category and a secondary category. In an example, a primary category for an abuse event can be labeled as a “large impact” and the secondary category for the abuse event can be labeled as “dropped on a hard surface”. A digital signal processing algorithm can be employed to facilitate prediction of the primary category for the abuse event. For instance, a digital signal processing algorithm (e.g., a low-level digital signal processing algorithm) can be employed to compare accelerometer data of the electronic device with one or more threshold values (e.g., three threshold value, etc.) to identify the primary category for the abuse event. The threshold values can be created, for example, using sample data. A machine learning algorithm can also be employed to facilitate prediction of the abuse event. For instance, a machine learning algorithm can employ (a) inertial data including accelerometer data, orientation data, rotational speed data and/or other data received from one or more sensors on the electronic device, (b) image data (e.g., image data captured by one or more images sensors of the electronic device) that includes one or more images of an environment in which the electronic device is operating, and/or (c) audio data that includes audio captured from one or more microphones of the electronic device as feature inputs. The machine learning algorithm can also compare the inertial data, the image data and/or the audio data against corresponding threshold values for each primary category type to predict the secondary category for the abuse event. Additionally, based on the primary category, the secondary category, and/or further analysis of data associated with the electronic device, a cloud service can provide one or more actionable recommendations related to the abuse event. In certain embodiments, the cloud service can perform further machine learning to facilitate providing one or more actionable recommendations related to the abuse event.

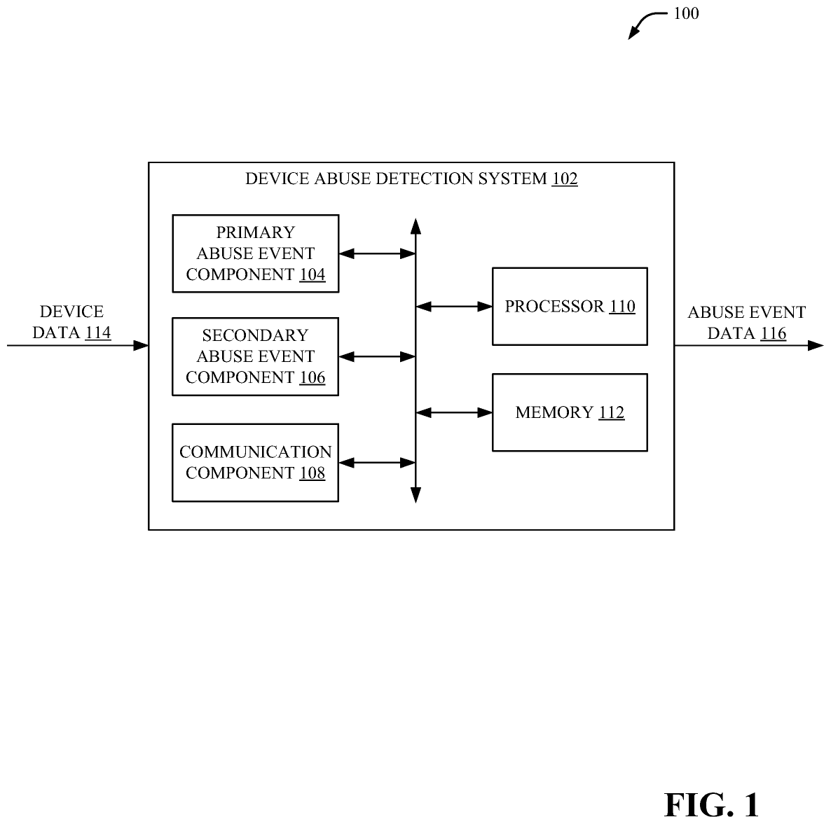

FIG. 1 illustrates a system 100 that provides an exemplary environment within which one or more described features of one or more embodiments of the disclosure can be implemented. According to an embodiment, the system 100 can include a device abuse detection system 102 to facilitate a practical application of detecting an abuse event associated with an electronic device. The device abuse detection system 102 can also be related to one or more technologies for detecting an abuse event associated with an electronic device, such as, for example, machine learning technologies, artificial intelligence technologies, digital signal processing technologies, sensor technologies, network technologies, electronic device technologies, computer technologies, and/or one or more other technologies. The device abuse detection system 102 can also employ hardware and/or software to solve one or more technical issues. Furthermore, the device abuse detection system 102 provides technical functionality that is not abstract and cannot be performed as a mental process by a human. Moreover, the device abuse detection system 102 can provide an improvement to one or more technologies such as electronic device technologies, device drop detection technologies, device abuse technologies, digital technologies and/or other technologies. In an implementation, the device abuse detection system 102 can improve performance of an electronic device. For example, the device abuse detection system 102 can improve performance of an electronic device and/or a state of health of an electronic device, as compared to conventional electronic devices. The device abuse detection system 102 can include a primary abuse event component 104, a secondary abuse event component 106 and/or a communication component 108. Additionally, in certain embodiments, the device abuse detection system 102 can include a processor 110 and/or a memory 112. In certain embodiments, one or more aspects of the device abuse detection system 102 (and/or other systems, apparatuses and/or processes disclosed herein) can constitute executable instructions embodied within a computer-readable storage medium (e.g., the memory 112). For instance, in an embodiment, the memory 112 can store computer executable component and/or executable instructions (e.g., program instructions). Furthermore, the processor 110 can facilitate execution of the computer executable components and/or the executable instructions (e.g., the program instructions). In an example embodiment, the processor 110 can be configured to execute instructions stored in the memory 112 or otherwise accessible to the processor 110.

The processor 110 can be a hardware entity (e.g., physically embodied in circuitry) capable of performing operations according to one or more embodiments of the disclosure. Alternatively, in an embodiment where the processor 110 is embodied as an executor of software instructions, the software instructions can configure the processor 110 to perform one or more algorithms and/or operations described herein in response to the software instructions being executed. In an embodiment, the processor 110 can be a single core processor, a multi-core processor, multiple processors internal to the device abuse detection system 102, a remote processor (e.g., a processor implemented on a server), and/or a virtual machine. In certain embodiments, the processor 110 be in communication with the memory 112, the primary abuse event component 104, the secondary abuse event component 106 and/or the communication component 108 via a bus to, for example, facilitate transmission of data among the processor 110, the memory 112, the primary abuse event component 104, the secondary abuse event component 106 and/or the communication component 108. The processor 110 can be embodied in a number of different ways and can, in certain embodiments, include one or more processing devices configured to perform independently. Additionally or alternatively, the processor 110 can include one or more processors configured in tandem via a bus to enable independent execution of instructions, pipelining of data, and/or multi-thread execution of instructions. The memory 112 can be non-transitory and can include, for example, one or more volatile memories and/or one or more non-volatile memories. In other words, for example, the memory 112 can be an electronic storage device (e.g., a computer-readable storage medium). The memory 112 can be configured to store information, data, content, one or more applications, one or more instructions, or the like, to enable the device abuse detection system 102 to carry out various functions in accordance with one or more embodiments disclosed herein. As used herein in this disclosure, the term “component,” “system,” and the like, can be and/or can include a computer-related entity. For instance, “a component,” “a system,” and the like disclosed herein can be either hardware, software, or a combination of hardware and software. As an example, a component can be, but is not limited to, a process executed on a processor, a processor, circuitry, an executable component, a thread of instructions, a program, and/or a computer entity.

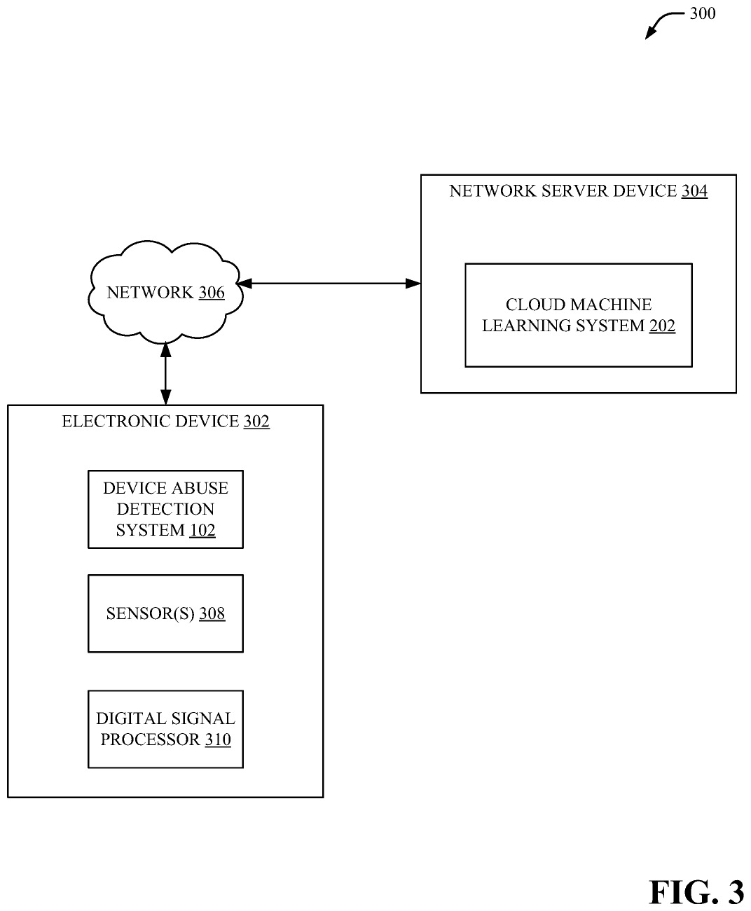

The device abuse detection system 102 (e.g., the primary abuse event component 104 of the device abuse detection system 102) can receive device data 114. The device data 114 can be data related to an electronic device (e.g., electronic device 302 shown in FIG. 3). The electronic device can be a mobile device such as, for example, a handheld computer, a smartphone, a tablet computer, a wearable device, a virtual reality device, an enterprise electronic device, a scanner device (e.g., a barcode scanner device), an industrial computer, or another type of electronic device. In an aspect, the device data 114 can be sensor data generated and/or obtained from one or more sensors of the electronic device. In an embodiment, the device data 114 can include accelerometer data generated and/or obtained from one or more accelerometer sensors of the electronic device. The one or more accelerometers sensors can measure acceleration related to the electronic device. Furthermore, in an embodiment, the accelerometer data can include first accelerometer data associated with an x-coordinate of the one or more accelerometer sensors of the electronic device, second accelerometer data associated with a y-coordinate of the one or more accelerometer sensors of the electronic device, and/or third accelerometer data associated with a z-coordinate of the one or more accelerometer sensors of the electronic device.

The primary abuse event component 104 can be related to a data generation process to facilitate identification of a primary abuse event category associated with the electronic device. In an aspect, the primary abuse event component 104 can compare the accelerometer data of the device data 114 with a plurality of defined accelerometer threshold values to identify a primary abuse event category associated with the electronic device. For instance, the primary abuse event component 104 can identify the primary abuse event category associated with the electronic device based on a first comparison between a first defined accelerometer threshold value and the first accelerometer data associated with the x-coordinate of the one or more accelerometer sensors, a second comparison between a second defined accelerometer threshold value and the second accelerometer data associated with the y-coordinate of the one or more accelerometer sensors, and a third comparison between a third defined accelerometer threshold value and the third accelerometer data associated with the z-coordinate of the one or more accelerometer sensors. The primary abuse event category can identify a type of abuse event for the electronic device. An abuse event can be a damage event (e.g., an intentional damage event) related to the electronic device that can result in potential damage (e.g., potential intentional damage) to the electronic device. For example, the primary abuse event category can identify an abuse event for the electronic device as a potential hit event, a potential drop event, a potential throw event, or another potential event that can cause damage (e.g., intentional damage) to the electronic device. The primary abuse event component 104 can employ a digital signal processing algorithm, in certain embodiments, to facilitate identification of the primary abuse event category associated with the electronic device. For instance, the primary abuse event component 104 can employ a digital signal processing algorithm to trigger the abuse event when one or more conditions related to the electronic device are satisfied. In an embodiment, the primary abuse event component 104 can identify the primary abuse event category as a potential hit event associated with the electronic device and/or a potential abuse event associated with the electronic device in response to a determination that the accelerometer data satisfies a defined sensor value. In another embodiment, the primary abuse event component 104 can identify the primary abuse event category as a potential throw event associated with the electronic device in response to a determination that the accelerometer data is above a defined sensor value for a certain interval of time.

The secondary abuse event component 106 can also be related to the data generation process. However, the secondary abuse event component 106 can employ one or more machine learning techniques to facilitate identification of a secondary abuse event category associated with the electronic device. For example, the secondary abuse event component 106 can employ one or more machine learning techniques to further analyze the device data 114 to identify the secondary abuse event category for the abuse event associated with the electronic device. In an aspect, the secondary abuse event component 106 can employ one or more machine learning techniques to generate a prediction (e.g., a first prediction) for the secondary abuse event category related to the abuse event associated with the electronic device. In an embodiment, the device data 114 can additionally include inertial data related to the electronic device, image data generated by the electronic device, and/or audio data captured by the electronic device. The inertial data can include the accelerometer data, orientation data, rotational speed data and/or other inertial data related to the electronic device. The inertial data can be generated and/or obtained from one or more inertial sensors of the electronic device. The one or more inertial sensors can measure orientation and/or rotational speed related to the electronic device. The image data can be generated and/or obtained from one or more image sensors of the electronic device. For example, the image data can be generated and/or obtained from one or more cameras of the electronic device. The image data can include one or more images related to an environment in which the electronic device operates. The audio data can be generated and/or obtained from one or more microphones of the electronic device. The audio data can include sound captured by the one or more microphones to, for example, provide context related to the abuse event and/or the environment in which the electronic device operates.

The secondary abuse event component 106 can identify a particular type of abuse event associated with the electronic device based on one or more machine learning techniques associated with the inertial data, the image data, and/or the audio data. Furthermore, the secondary abuse event category can more accurately identify a type of abuse event for the electronic device, as compared to the primary abuse event category. In an aspect, the secondary abuse event category can identify a subclass for the primary abuse event category (e.g., a subclass for a hit event, a subclass for a throw event, etc.). For instance, the secondary abuse event component 106 can identify a particular type of abuse event associated with the electronic device based on the machine learning technique associated with the inertial data, the image data, and/or the audio data. The secondary abuse event component 106 can also classify other contextual data associated with the abuse event such as, for example, a type of surface associated with the abuse event (e.g., a type of surface that the electronic device hits, etc.), a type of action associated with the abuse event, a height of a throw associated with the abuse event, a type of throw associated with the abuse event, a distance of a throw associated with the abuse event, etc. In an example, the secondary abuse event category can identify an abuse event for the electronic device as a free fall event, an event related to throwing the electronic device on the ground at a near distance, an event related to throwing the electronic device on the ground at a far distance, an event related to throwing the electronic device upwards and allowing the electronic device to subsequently free fall, an event related to dropping the electronic device on a soft surface, an event related to dropping the electronic device on a hard surface, or another potential event that can cause damage to the electronic device. Furthermore, the secondary abuse event category can indicate that the electronic device is not related to a hit event, a drop event or a throw event. The secondary abuse event component 106 can employ one or more machine learning algorithms to facilitate identification of the secondary abuse event category associated with the electronic device. Additionally, in an embodiment, the secondary abuse event component 106 can generate abuse event data 116. The abuse event data 116 can include the identification of the secondary abuse event category associated with the electronic device. Furthermore, the abuse event data 116 can additionally or alternatively include data related to the secondary abuse event category such as, for example, the inertial data, the image data, and/or the audio data.

In an embodiment, the secondary abuse event component 106 can employ one or more machine learning process and/or one or more artificial intelligence techniques to identify the secondary abuse event category associated with the electronic device. For example, the secondary abuse event component 106 can perform learning (e.g., deep learning, etc.) with respect to at least a portion of the device data 114 (e.g., the inertial data, the image data, and/or the audio data) to determine one or more classifications, one or more correlations, one or more expressions, one or more inferences, one or more patterns, one or more features and/or other learned information related to the device data 114 (e.g., the inertial data, the image data, and/or the audio data). In an aspect, the secondary abuse event component 106 can employ one or more machine learning process and/or one or more artificial intelligence techniques to generate the prediction (e.g., the first prediction) for the secondary abuse event category related to the abuse event associated with the electronic device. The learning performed by the secondary abuse event component 106 can be performed explicitly or implicitly with respect to at least a portion of the device data 114 (e.g., the inertial data, the image data, and/or the audio data). In another aspect, the secondary abuse event component 106 can employ a machine learning model (e.g., a classification model, a machine learning classifier, etc.) to determine one or more classifications, one or more correlations, one or more expressions, one or more inferences, one or more patterns, one or more features and/or other learned information related to the device data 114 (e.g., the inertial data, the image data, and/or the audio data). In an example, the machine learning model (e.g., a classification model, a machine learning classifier, etc.) employed by the secondary abuse event component 106 can utilize one or more inference-based schemes to determine one or more classifications, one or more correlations, one or more expressions, one or more inferences, one or more patterns, one or more features and/or other learned information related to the device data 114 (e.g., the inertial data, the image data, and/or the audio data). In an aspect, the portion of the device data 114 (e.g., the inertial data, the image data, and/or the audio data) can be provided as input to the machine learning model (e.g., the classification model, the machine learning classifier, etc.) to facilitate the or more machine learning process and/or the one or more artificial intelligence techniques to identify the secondary abuse event category associated with the electronic device. Furthermore, output of the machine learning model (e.g., the classification model, the machine learning classifier, etc.) can be, for example, the prediction (e.g., the first prediction) for the secondary abuse event category related to the abuse event associated with the electronic device. In certain embodiments, output of the machine learning model can be associated with a data model description. For example, the data model description can describe one or more abuse detection events in a computer format. In an aspect, the data model description can include event properties and/or data associated with hardware, sensors and/or other data that are employed to facilitate detection of an abuse event. Additionally or alternatively, the data model description can include data associated with digital signal processing. Additionally or alternatively, the data model description can include data associated with one or more machine learning processes. Additionally or alternatively, the data model description can include data associated with a prediction for an abuse event category (e.g., a primary abuse event category and/or a secondary abuse event category). The data model description can additionally or alternatively include other data such as, for example, a timestamp associated with the abuse event, electronic device data for an electronic device associated with the abuse event, audio data associated with the abuse event, image data associated with the abuse event, and/or other data associated with the abuse event.

In one embodiment, the secondary abuse event component 106 can employ a support vector machine (SVM) classifier to determine one or more classifications, one or more correlations, one or more expressions, one or more inferences, one or more patterns, one or more features and/or other learned information related to the device data 114 (e.g., the inertial data, the image data, and/or the audio data). In another embodiment, the secondary abuse event component 106 can employ one or more machine learning classification techniques associated with a Bayesian machine learning network, a binary classification model, a multiclass classification model, a linear classifier model, a quadratic classifier model, a neural network model, a probabilistic classification model, decision trees and/or one or more other classification models. The machine learning model (e.g., the classification model, the machine learning classifier, etc.) employed by the secondary abuse event component 106 can be explicitly trained (e.g., via training data) and/or implicitly trained (e.g., via extrinsic data received by the machine learning model). For example, the machine learning model (e.g., the classification model, the machine learning classifier, etc.) employed by the secondary abuse event component 106 can be trained with training data that includes one or more samples of an abuse event (e.g., a throw event, a drop event, a hit event, a free fall event, an event related to throwing the electronic device on the ground at a near distance, an event related to throwing the electronic device on the ground at a far distance, an event related to throwing the electronic device upwards and allowing the electronic device to subsequently free fall, an event related to dropping the electronic device on a soft surface, an event related to dropping the electronic device on a hard surface, or another potential event that can cause damage to the electronic device, etc.).

The communication component 108 can be related to a data collection process. For example, the communication component 108 can collect data associated with the abuse event (e.g., data associated with the data generation process by the primary abuse event component 104 and/or the secondary abuse event component 106). Furthermore, the communication component 108 can transmit the data associated with the abuse event to a network server device (e.g., a central cloud service) for further machine learning analysis of the data associated with the abuse event. For instance, the communication component 108 can transmit the abuse event data 116 to a network server device associated with a machine learning service to facilitate generation of a second prediction for the secondary abuse event category based on the abuse event data 116. In an embodiment, the communication component 108 can transmit the inertial data, the image data and/or the audio data to a network server device associated with a machine learning service to facilitate generation of a second prediction for the secondary abuse event category based on the inertial data, the image data, and/or the audio data. In certain embodiments, the communication component 108 can receive a machine learning model (e.g., a machine learning classifier) from the network server device. Furthermore, the secondary abuse event component 106 can generate the first prediction for the secondary abuse event category based on a machine learning model received from the network server device associated with the machine learning service. In certain embodiments, the communication component 108 can receive, from the network server device, a notification that is generated based on the first prediction for the secondary abuse event category and the second prediction for the secondary abuse event category. For example, the notification can be an email message, a text message, an over the air (OTA) message, a warning message (e.g., an alert message), a sound, a vibration and/or another notification for the electronic device that can alert a user (e.g., a user of the electronic device) of the abuse event. In certain embodiments, the communication component 108 can receive, from the network server device, feedback data from the network server device to alter one or more functionalities of the electronic device.

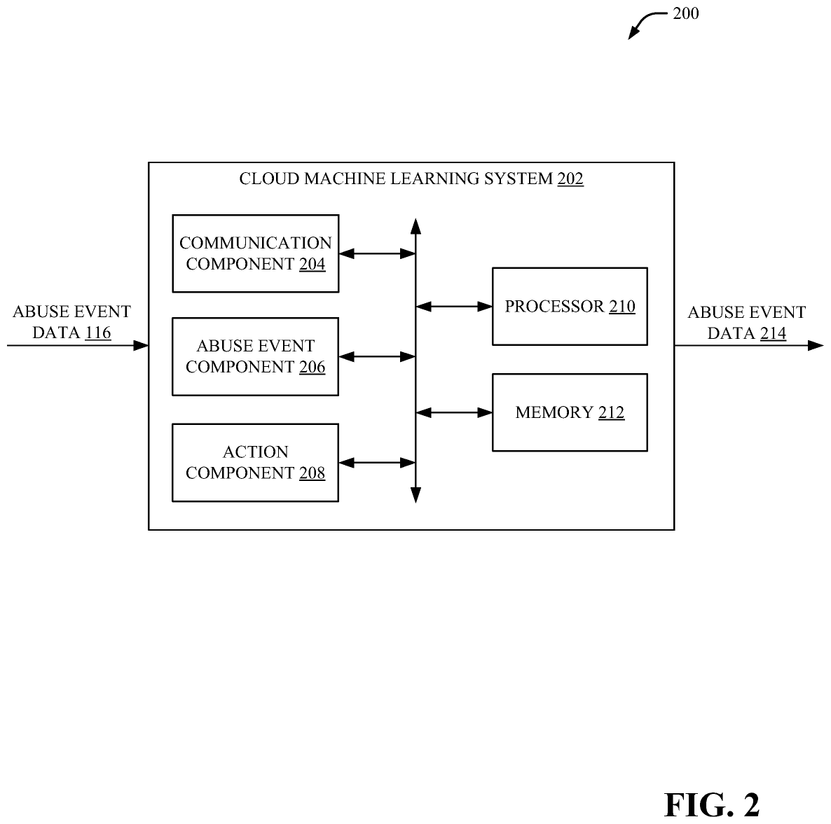

FIG. 2 illustrates a system 200 that provides an exemplary environment within which one or more described features of one or more embodiments of the disclosure can be implemented. According to an embodiment, the system 200 can include a cloud machine learning system 202 to facilitate a practical application of detecting an abuse event associated with an electronic device. The cloud machine learning system 202 can also be related to one or more technologies for detecting an abuse event associated with an electronic device, such as, for example, machine learning technologies, artificial intelligence technologies, digital signal processing technologies, network technologies, server technologies, cloud computing technologies, computer technologies, and/or one or more other technologies. The cloud machine learning system 202 can also employ hardware and/or software to solve one or more technical issues. Furthermore, the cloud machine learning system 202 provides technical functionality that is not abstract and cannot be performed as a mental process by a human. Moreover, the cloud machine learning system 202 can provide an improvement to one or more technologies such as electronic device technologies, device drop detection technologies, device abuse technologies, digital technologies and/or other technologies. In an implementation, the cloud machine learning system 202 can improve performance of an electronic device. For example, the cloud machine learning system 202 can improve performance of an electronic device and/or a state of health of an electronic device, as compared to conventional electronic devices. The cloud machine learning system 202 can include a communication component 204, an abuse event component 206 and/or an action component 208. Additionally, in certain embodiments, the cloud machine learning system 202 can include a processor 210 and/or a memory 212. In certain embodiments, one or more aspects of the cloud machine learning system 202 (and/or other systems, apparatuses and/or processes disclosed herein) can constitute executable instructions embodied within a computer-readable storage medium (e.g., the memory 212). For instance, in an embodiment, the memory 212 can store computer executable component and/or executable instructions (e.g., program instructions). Furthermore, the processor 210 can facilitate execution of the computer executable components and/or the executable instructions (e.g., the program instructions). In an example embodiment, the processor 210 can be configured to execute instructions stored in the memory 212 or otherwise accessible to the processor 210.

The processor 210 can be a hardware entity (e.g., physically embodied in circuitry) capable of performing operations according to one or more embodiments of the disclosure. Alternatively, in an embodiment where the processor 210 is embodied as an executor of software instructions, the software instructions can configure the processor 210 to perform one or more algorithms and/or operations described herein in response to the software instructions being executed. In an embodiment, the processor 210 can be a single core processor, a multi-core processor, multiple processors internal to the cloud machine learning system 202, a remote processor (e.g., a processor implemented on a server), and/or a virtual machine. In certain embodiments, the processor 210 be in communication with the memory 212, the communication component 204, the abuse event component 206 and/or the action component 208 via a bus to, for example, facilitate transmission of data among the processor 210, the memory 212, the communication component 204, the abuse event component 206 and/or the action component 208. The processor 210 can be embodied in a number of different ways and can, in certain embodiments, include one or more processing devices configured to perform independently. Additionally or alternatively, the processor 210 can include one or more processors configured in tandem via a bus to enable independent execution of instructions, pipelining of data, and/or multi-thread execution of instructions. The memory 212 can be non-transitory and can include, for example, one or more volatile memories and/or one or more non-volatile memories. In other words, for example, the memory 212 can be an electronic storage device (e.g., a computer-readable storage medium). The memory 212 can be configured to store information, data, content, one or more applications, one or more instructions, or the like, to enable the cloud machine learning system 202 to carry out various functions in accordance with one or more embodiments disclosed herein.

The cloud machine learning system 202 (e.g., the communication component 204 of the cloud machine learning system 202) can receive the abuse event data 116 transmitted by the device abuse detection system 102 (e.g., the communication component 108 of the device abuse detection system 102). For example, in response to the first prediction for the secondary abuse event category being determined by the device abuse detection system 102, the communication component 204 can receive the inertial data, the image data, and/or the audio data. The communication component 204 can also facilitate one or more other communications between the device abuse detection system 102 and the cloud machine learning system 202. In an aspect, the communication component 204 can communicate with the communication component 108 of the device abuse detection system 102.

The abuse event component 206 can generate a second prediction for the secondary abuse event category based on a machine learning process associated with the abuse event data 116. The machine learning process employed by the abuse event component 206 can be different than (e.g., more complex than) the machine learning process employed by the secondary abuse event component 106. For instance, the abuse event component 206 can generate a second prediction for the secondary abuse event category based on a machine learning process associated with the inertial data, the image data, and the audio data. Additionally or alternatively, the abuse event component 206 can generate the second prediction for the secondary abuse event category based on device history data associated with the electronic device, trend data associated with a time of day or a season of year for the potential abuse event, trend data associated with a type of customer segment for the electronic device, trend data associated with a user type associated with the electronic device. The abuse event component 206 can also compare the second prediction for the secondary abuse event category and the first prediction for the secondary abuse event category. As such, the abuse event component 206 can be employed to verify accuracy of the first prediction for the secondary event category generated by the device abuse detection system 102.In an embodiment, the abuse event component 202 can employ one or more machine learning process and/or one or more artificial intelligence techniques to identify the secondary abuse event category associated with the electronic device. For example, the abuse event component 202 can perform learning (e.g., deep learning, etc.) with respect to the abuse event data 116, the device history data and/or the trend data to determine one or more classifications, one or more correlations, one or more expressions, one or more inferences, one or more patterns, one or more features and/or other learned information related to the abuse event data 116, the device history data and/or the trend data. In an aspect, the abuse event component 202 can employ one or more machine learning process and/or one or more artificial intelligence techniques to generate the prediction (e.g., the second prediction) for the secondary abuse event category related to the abuse event associated with the electronic device. The learning performed by the abuse event component 202 can be performed explicitly or implicitly with respect to the abuse event data 116, the device history data and/or the trend data. In another aspect, the abuse event component 202 can employ a machine learning model (e.g., a classification model, a machine learning classifier, etc.) to determine one or more classifications, one or more correlations, one or more expressions, one or more inferences, one or more patterns, one or more features and/or other learned information related to the abuse event data 116, the device history data and/or the trend data. In an example, the machine learning model (e.g., a classification model, a machine learning classifier, etc.) employed by the abuse event component 202 can utilize one or more inference-based schemes to determine one or more classifications, one or more correlations, one or more expressions, one or more inferences, one or more patterns, one or more features and/or other learned information related to the abuse event data 116, the device history data and/or the trend data. In an aspect, the abuse event data 116, the device history data and/or the trend data can be provided as input to the machine learning model (e.g., the classification model, the machine learning classifier, etc.) to facilitate the or more machine learning process and/or the one or more artificial intelligence techniques to identify the secondary abuse event category associated with the electronic device. Furthermore, output of the machine learning model (e.g., the classification model, the machine learning classifier, etc.) can be, for example, the prediction (e.g., the second prediction) for the secondary abuse event category related to the abuse event associated with the electronic device.

In one embodiment, the abuse event component 202 can employ a SVM classifier to determine one or more classifications, one or more correlations, one or more expressions, one or more inferences, one or more patterns, one or more features and/or other learned information related to the abuse event data 116, the device history data and/or the trend data. In another embodiment, the abuse event component 202 can employ one or more machine learning classification techniques associated with a Bayesian machine learning network, a binary classification model, a multiclass classification model, a linear classifier model, a quadratic classifier model, a neural network model, a probabilistic classification model, decision trees and/or one or more other classification models. The machine learning model (e.g., the classification model, the machine learning classifier, etc.) employed by the abuse event component 202 can be explicitly trained (e.g., via training data) and/or implicitly trained (e.g., via extrinsic data received by the machine learning model). For example, the machine learning model (e.g., the classification model, the machine learning classifier, etc.) employed by the abuse event component 202 can be trained with training data that includes one or more samples of an abuse event (e.g., a throw event, a drop event, a hit event, a free fall event, an event related to throwing the electronic device on the ground at a near distance, an event related to throwing the electronic device on the ground at a far distance, an event related to throwing the electronic device upwards and allowing the electronic device to subsequently free fall, an event related to dropping the electronic device on a soft surface, an event related to dropping the electronic device on a hard surface, or another potential event that can cause damage to the electronic device, etc.).

In an embodiment, the action component 208 can initiate an action associated with the electronic device based on the first prediction for the secondary abuse event category and the second prediction for the secondary abuse event category. In response to a determination that the second prediction for the secondary abuse event category corresponds to the first prediction for the secondary abuse event category, it can be determined that the first prediction for the secondary abuse event category is correct. Furthermore, in response to a determination that the second prediction for the secondary abuse event category corresponds to the first prediction for the secondary abuse event category, the action component 208 can initiate one or more actions related to notifying one or more administrators. A notification for an administrator can include, for example, information related to an issue with the electronic device, information related to user behaviors associated with the electronic device, information related to training needs for a user associated with the electronic device, information related to repair needs for the electronic device and/or other information related to the electronic device and/or a user associated with the electronic device. In certain embodiments, a notification can be configured based on a user profile associated with the electronic device and/or an administrator notification profile. In certain embodiments, a notification can facilitate notification of details regarding collected data for a device abuse event from one or more electronic devices, estate-wide awareness of potential electronic device abuse, awareness of user behavior with respect to electronic devices, an ability to compare different locations and/or different users regarding how electronic devices are being used, and/or warranty impact determination when electronic devices are in need of repair. Additionally or alternatively, in response to a determination that the second prediction for the secondary abuse event category corresponds to the first prediction for the secondary abuse event category, the action component 208 can initiate one or more actions related to the electronic device. For example, in response to a determination that the second prediction for the secondary abuse event category corresponds to the first prediction for the secondary abuse event category, the action component 208 can transmit one or more notifications to the electronic device. For example, the notification can be an email message for the electronic device, a text message for the electronic device, an OTA message for the electronic device, a warning message (e.g., an alert message) for the electronic device, a sound to be generated by the electronic device, a vibration to be generated by the electronic device, and/or another notification for the electronic device that can alert a user (e.g., a user of the electronic device) of the abuse event. Additionally or alternatively, in response to a determination that the second prediction for the secondary abuse event category corresponds to the first prediction for the secondary abuse event category, the action component 208 can alter one or more functionalities of the electronic device.

However, in response to a determination that the second prediction for the secondary abuse event category does not correspond to the first prediction for the secondary abuse event category, the action component 208 can train (e.g., retrain) a machine learning model (e.g., a machine learning classifier, a classification model, etc.) employed by the device abuse detection system 102 based on the second prediction for the secondary abuse event category. For example, in response to a determination that the second prediction for the secondary abuse event category does not correspond to the first prediction for the secondary abuse event category, the action component 208 can train (e.g., retrain) a machine learning model (e.g., a machine learning classifier, a classification model, etc.) employed by the device abuse detection system 102 based on the abuse event data 116 and/or the machine learning process associated with the abuse event data 116. The machine learning model (e.g., the machine learning classifier, the classification model, etc.) can be a machine learning model to facilitate classification of the secondary abuse event category. In certain embodiments, one or more thresholds (e.g., one or more classification thresholds) for the machine learning model can be altered based on the abuse event data 116 and/or the machine learning process associated with the abuse event data 116. In an embodiment, the communication component 204 can transmit, to the electronic device, a retrained version of the machine learning model (e.g., the machine learning classifier, the classification model, etc.) for the secondary abuse event category. Additionally, in an embodiment, the abuse event component 206 can generate abuse event data 214. The abuse event data 214 can include the identification of the secondary abuse event category (e.g., the second prediction for the secondary abuse event category) determined by the abuse event component 206.

In certain embodiments, the communication component 204 can receive data from one or more other electronic devices. Furthermore, the action component 208 can train (e.g., retrain) the machine learning model (e.g., the machine learning classifier, the classification model, etc.) based on the abuse event data 116 and/or the data associated with the one or more other electronic devices. For example, the action component 208 can train (e.g., retrain) the machine learning model (e.g., the machine learning classifier, the classification model, etc.) based on the inertial data, the image data, the audio data, and/or the data associated with the one or more other electronic devices. In certain embodiments, the action component 208 can additionally or alternatively initiate an action associated with the electronic device based on device history data associated with the electronic device. In certain embodiments, the action component 208 can additionally or alternatively initiate an action associated with the electronic device based on trend data associated with a time of day or a season of year. In certain embodiments, the action component 208 can additionally or alternatively initiate an action associated with the electronic device based on trend data associated with a type of customer segment for the electronic device. In certain embodiments, the action component 208 can additionally or alternatively initiate an action associated with the electronic device based on trend data associated with a user type associated with the electronic device.

FIG. 3 illustrates a system 300 that provides an exemplary environment within which one or more of the described features of one or more embodiments of the disclosure can be implemented. Repetitive description of like elements described in other embodiments herein is omitted for sake of brevity. The system 300 includes an electronic device 302 and a network server device 304. The electronic device 302 can communicate with the network server device 304 via a network 306. The electronic device 302 can be a mobile device such as, for example, a handheld computer, a smartphone, a tablet computer, a wearable device, a virtual reality device, an enterprise electronic device, a scanner device (e.g., a barcode scanner device), an industrial computer, or another type of electronic device. Furthermore, the electronic device 302 can be associated with a potential abuse event. The network server device 304 can be a server system (e.g., a cloud computing system) associated with one or more servers.

The electronic device 302 can include the device abuse detection system 102, one or more sensors 308 and/or a digital signal processor 310 to facilitate detection of an abuse event associated with the electronic device 302. The network server device 304 can include the cloud machine learning system 202. The network server device 304 that includes the cloud machine learning system 202 can also facilitate detection of an abuse event associated with the electronic device 302. The one or more sensors 308 can include one or more accelerometer sensors, one or more inertial sensors, one or more image sensors, one or more abuse sensors (e.g., one or more virtual abuse sensors), and/or one or more other sensors. The one or more sensors 308 can, for example, generate at least a portion of the device data 114. For example, the one or more sensors 308 can generate the accelerometer data, the inertial data, and/or the image data employed by the device abuse detection system 102. The digital signal processor 310 can facilitate digital signal processing performed by the device abuse detection system 102 to identify the primary abuse event category associated with the electronic device 302. The one or more sensors 308 can also facilitate identifying the primary abuse event category associated with the electronic device 302. Furthermore, the one or more sensors 308 can facilitate identifying the first prediction for the secondary abuse event category associated with the electronic device 302. In an embodiment, the electronic device 302 (e.g., the device abuse detection system 102) can transmit the abuse event data 116 to the network server device 304 (e.g., the cloud machine learning system 202) via the network 306. The network 306 can be a communications network that employs wireless technologies and/or wired technologies to transmit data between the electronic device 302 and the network server device 304. For example, the network 306 can be a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or another type of network.

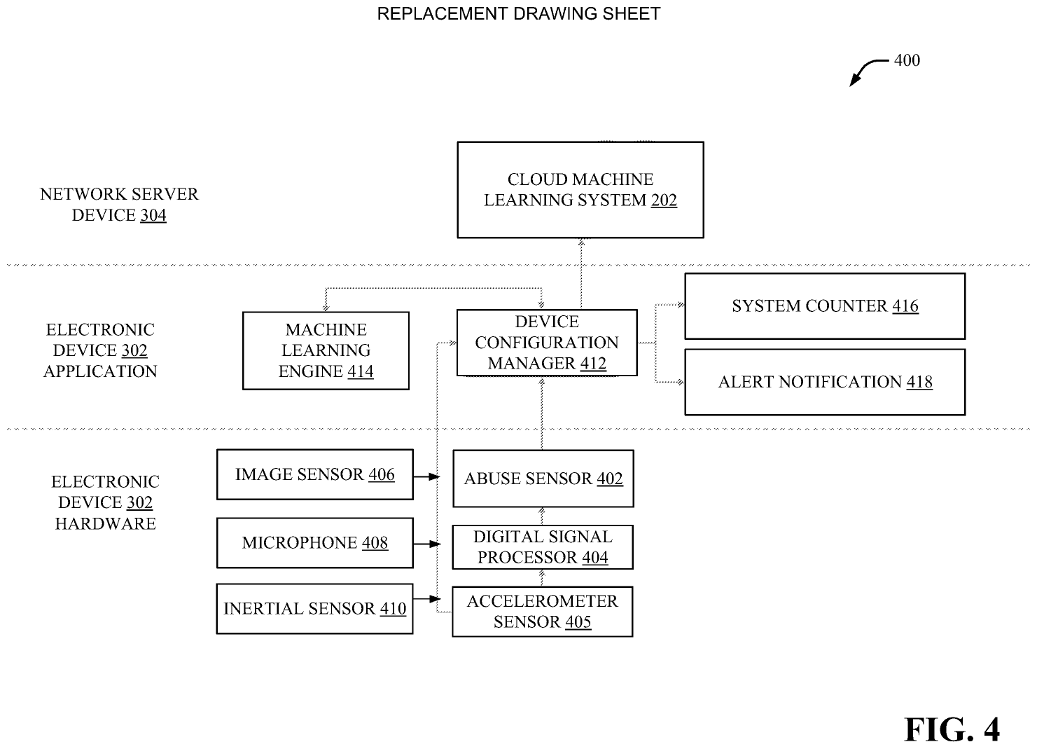

FIG. 4 illustrates a system 400 that provides an exemplary environment within which one or more of the described features of one or more embodiments of the disclosure can be implemented. Repetitive description of like elements described in other embodiments herein is omitted for sake of brevity. The system 400 includes a hardware portion for the electronic device 302, an application portion for the electronic device 302, and a portion of the network server device 304. The hardware portion for the electronic device 302 can include an abuse sensor 402, a digital signal processor 404, an accelerometer sensor 404, an image sensor 406, a microphone 408, and/or an inertial sensor 410. The abuse sensor 402 can be configured to sense an abuse condition associated with the electronic device 302. The abuse sensor 402 can also generate at least a portion of the accelerometer data. Additionally, in certain embodiments, the abuse sensor 402 can be implemented in connection with a hard drive of the electronic device 302. The digital signal processor 404 can correspond to the digital signal processor 310, for example. The digital signal processor 404 can facilitate a digital signal process performed by the electronic device 302. The accelerometer sensor 405 can generate at least a portion of the accelerometer data. The image sensor 406 can generate at least a portion of the image data. The microphone 408 can generate at least a portion of the audio data. The inertial sensor 410 can generate at least a portion of the inertial data.

The device configuration manager 412 can facilitate management of data associated with the abuse sensor 402, the digital signal processor 404, the accelerometer sensor 404, the image sensor 406, the microphone 408, and/or the inertial sensor 410. Additionally or alternatively, the device configuration manager 412 can facilitate management of data associated with a machine learning engine 414, a system counter 416, an alert notification 418, and/or cloud machine learning system 202 of the network server device 304. In an embodiment, the machine learning engine 414 can manage one or more machine learning processes performed by the secondary abuse event component 106 to identify the first prediction for the secondary abuse event category associated with the electronic device 302. Furthermore, the cloud machine learning system 202 can manage one or more different machine learning processes to identify the second prediction for the secondary abuse event category associated with the electronic device 302. In an embodiment, the one or more different machine learning processes performed by the cloud machine learning system 202 can be more complex than the one or more machine learning processes performed by the secondary abuse event component 106. The system counter 416 can be employed to determine an interval of time that the accelerometer data is above a defined sensor value associated with the accelerometer sensor 405 and/or the abuse sensor 402. The alert notification 418 can be one or more notifications provided by the cloud machine learning system 202. In an embodiment, the alert notification 418 can be presented via a display (e.g., a graphical user interface) of the electronic device 302. In another embodiment, the alert notification 418 can be presented as a sound notification and/or a vibration notification via the electronic device 302.

In an example embodiment, the digital signal processor 404 can determine whether an abuse event (e.g., a throw event or a hit event) has occurred for the electronic device 302 based on data from the accelerometer sensor 405 and/or the abuse sensor 402. For example, the digital signal processor 404 can determine whether an abuse event (e.g., a throw event or a hit event) has occurred for the electronic device 302 based on whether data from the accelerometer sensor 405 and/or the abuse sensor 402 satisfies one or more threshold values. The cloud machine learning system 202 can receive data associated with the abuse event and/or raw data of the accelerometer sensor 405 and/or the abuse sensor 402. The cloud machine learning system 202 can perform machine learning classification with respect to the data associated with the abuse event and/or raw data of the accelerometer sensor 405 and/or the abuse sensor 402. For example, the cloud machine learning system 202 can employ raw accelerometer sensor data (e.g., accelerometer x-coordinate data, accelerometer y-coordinate data, and accelerometer z-coordinate data) to perform further analysis and/or distinction for the abuse event. For example, in response to the cloud machine learning system 202 receiving data related to a throw event and/or accelerometer sensor data related to the throw event, the cloud machine learning system 202 can employ a machine learning model to further analyze the data related to a throw event and/or accelerometer sensor data related to the throw event. Furthermore, a result of the machine learning process associated with the machine learning model can provide a determination as to whether the throw event is an actual throw event or another type of non-abuse event such as a user throwing and catching the electronic device 302, etc. In an aspect, the machine learning model employed by the cloud machine learning system 202 can be trained based on data samples of abuse events. For example, the machine learning model employed by the cloud machine learning system 202 can be trained based on data samples of hit events and throw events. The raw data can also be provided as input to the machine learning model to generate an output value as either a hit event or a throw event.

In certain embodiments, the cloud machine learning system 202 can employ additional data such as maximum acceleration, free fall time, a time of day, customer segments, customer type, history of the electronic device 302 and/or other trend data for the machine learning process associated with the machine learning model. In an aspect, based on the additional data, the cloud machine learning system 202 can provide a re-classification of the abuse event. For example, in a scenario where the electronic device 302 is a retail customer device and numerous hit abuse events are reported with maximum acceleration that is less than a certain defined value and a time of day at 2:00 AM (e.g., not a normal working hour for a retail employee), the cloud machine learning system 202 can tag these events as non-abuse events instead of abuse events. Additionally, in certain embodiments, the cloud machine learning system 202 can retrain the machine learning model to generate a new machine learning model. The cloud machine learning system 202 can also provide the new machine learning model to the machine learning engine 414 associated with the electronic device 302. With the new machine learning model, electronic device 302 can provide improved prediction of an abuse event and/or can provide more accurate abuse event results. As such, the cloud machine learning system 202 can repeatedly refine a machine learning model for the machine learning engine 414 associated with the electronic device 302. Moreover, the cloud machine learning system 202 can provide details from collected abuse data from multiple electronic devices. As such, the cloud machine learning system 202 can provide estate-wide awareness of potential electronic device abuse and/or user behavior. The cloud machine learning system 202 can also provide an ability to compare different locations and/or different users on how electronic devices are being used. Additionally, the cloud machine learning system 202 can improve warranty determination when electronic devices undergo repair based on abuse information gathered by the cloud machine learning system 202.

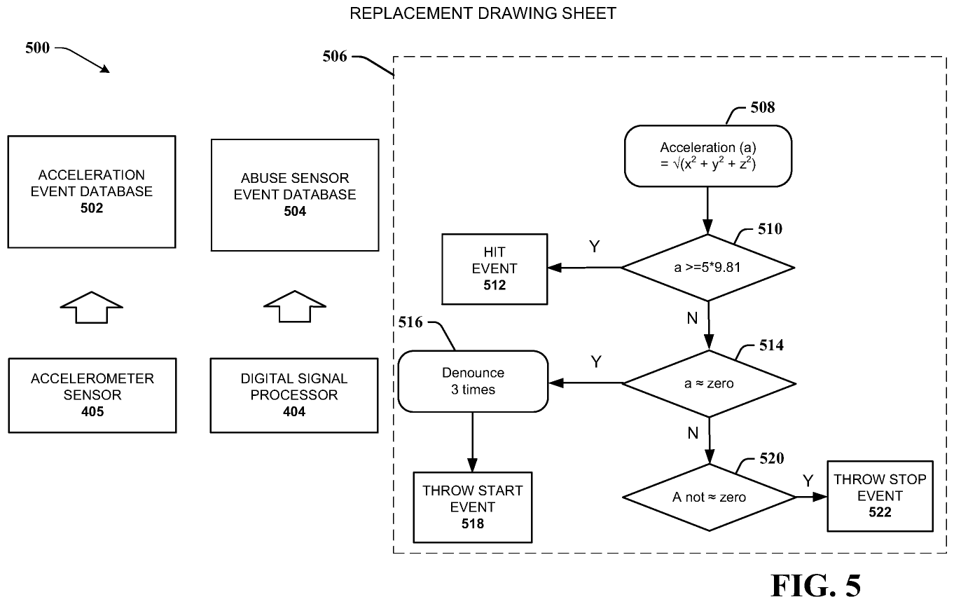

FIG. 5 illustrates a system 500 in accordance with one or more embodiments of the disclosure can be implemented. Repetitive description of like elements described in other embodiments herein is omitted for sake of brevity. The system 500 includes the digital signal processor 404 and the accelerometer sensor 405. The accelerometer sensor 405 can generate data that is stored in an acceleration event database 502. For example, the acceleration event database 502 can store data associated with one or more acceleration events. An acceleration event can include data associated with an x-coordinate of the accelerometer sensor 405, a y-coordinate of the accelerometer sensor 405, and/or a z-coordinate of the accelerometer sensor 405. For example, a first acceleration event can include first x-coordinate data of the accelerometer sensor 405, first y-coordinate data of the accelerometer sensor 405, and first z-coordinate data of the accelerometer sensor 405. Furthermore, a second acceleration event can include second x-coordinate data of the accelerometer sensor 405, second y-coordinate data of the accelerometer sensor 405, and second z-coordinate data of the accelerometer sensor 405, etc. In an embodiment, the data stored in the acceleration event database 502 (e.g., the data associated with one or more acceleration events) can be processed by the digital signal processor 404. Furthermore, the digital signal processor 404 can generate, based on the data stored in the acceleration event database 502, data associated with one or more abuse sensor events. For example, the digital signal processor 404 can determine at least a portion of the data stored in the acceleration event database 502 that is associated with an abuse event. The digital signal processor 404 can also store the data associated with one or more abuse sensor events in an abuse sensor event database 504.

In an embodiment, the digital signal processor 404 can perform a digital signal process 506 to determine the data associated with one or more abuse sensor events. The digital signal process 506 can include a step 508 where acceleration (e.g., Acceleration (a)) is determined. For example, at the step 508, acceleration can be equal to √(x²+y²+z²), where x is x-coordinate data of the accelerometer sensor 405, y is y-coordinate data of the accelerometer sensor 405, and z is z-coordinate data of the accelerometer sensor 405. The digital signal process 506 can also include a step 510 where it is determined whether acceleration (e.g., Acceleration (a)) is greater than a threshold value equal to 5*9.81. If yes, the digital signal process 506 can determine that hit event 512 is associated with the electronic device 302. If no, the digital signal process 506 can perform a step 514 that determines whether acceleration (e.g., Acceleration (a)) is approximately equal to zero. If yes, the digital signal process 506 can perform a step 516 that determines multiple times (e.g., three times) that the acceleration (e.g., Acceleration (a)) is not approximately equal to zero, and a throw start event 518 is initiated. If, the digital signal process 506 determines no for the first time (e.g., the digital signal process 506 determines for the first time that the is not approximately equal to zero), the digital process 506 can return to the step 508. After the step 516, the digital signal process 506 can perform a step 520 that determines whether the acceleration (e.g., Acceleration (a)) is not approximately equal to zero. If yes, a throw stop event 522 can be initiated.

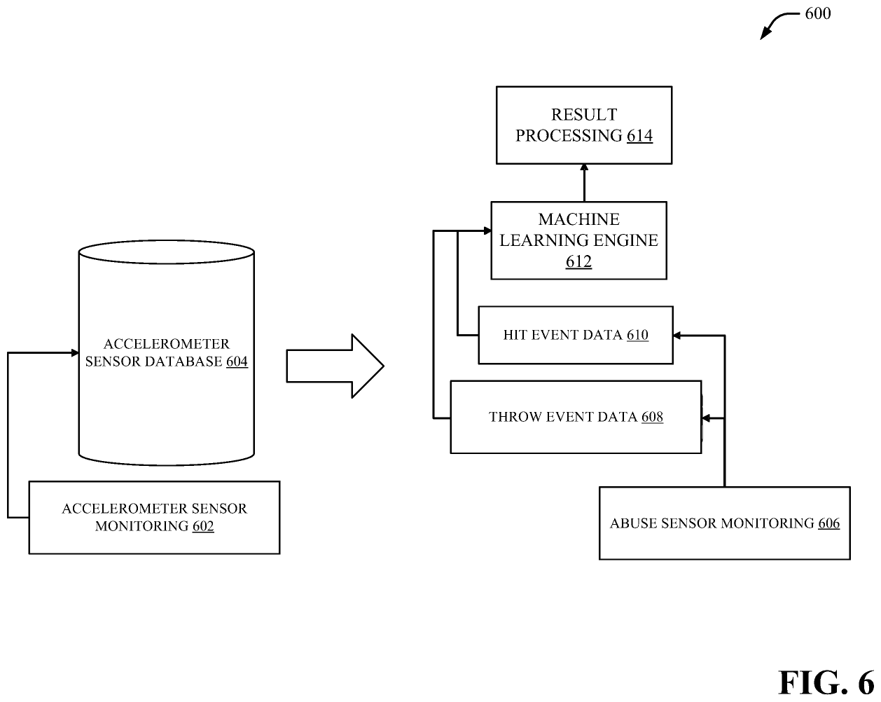

FIG. 6 illustrates a system 600 in accordance with one or more embodiments of the disclosure can be implemented. Repetitive description of like elements described in other embodiments herein is omitted for sake of brevity. The system 600 can include accelerometer sensor monitoring 602 that repeatedly stores samples (e.g., samples within a last second) in an accelerometer sensor database 604. The system 600 can additionally include abuse sensor monitoring 606 that generates throw event data 608. For example, the throw event data 608 can include data associated with the throw start event 518 and/or the throw stop event 522. In an embodiment, the abuse sensor monitoring 606 can filter samples from the accelerometer sensor database 604. The abuse sensor monitoring 606 can additionally or alternatively generate hit event data 610. The hit event data 610 can include, for example, data associated with the hit event 512. A machine learning engine 612 can employ the throw event data 608 and/or the hit event data 610 to perform one or more machine learning processes related to generating a prediction (e.g., the first prediction) for the secondary abuse event category associated with the electronic device 302. The machine learning engine 612 can correspond to the machine learning engine 414, for example. In an embodiment, the machine learning engine 612 can be associated with a machine learning process performed by the secondary abuse event component 106. Result processing 614 can provide, for example, a result associated with the machine learning engine 612. For example, the result processing 614 can provide the prediction (e.g., the first prediction) for the secondary abuse event category associated with the electronic device 302. In another embodiment, the result processing 614 can include initiating one or more actions related to the prediction (e.g., the first prediction) for the secondary abuse event category associated with the electronic device 302.

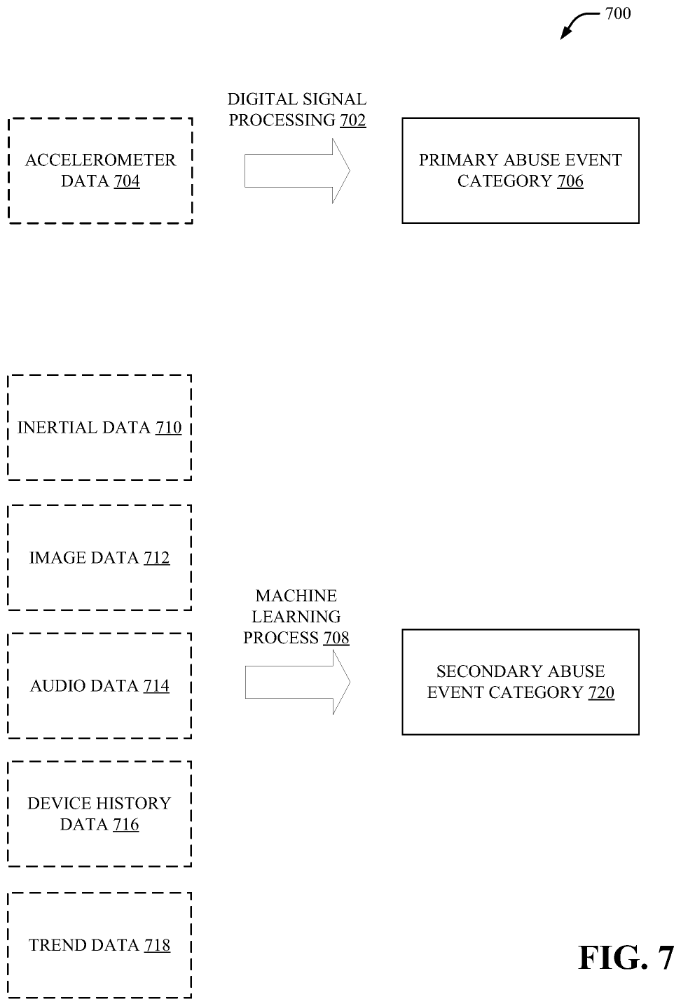

FIG. 7 illustrates a system 700 in accordance with one or more embodiments of the disclosure can be implemented. Repetitive description of like elements described in other embodiments herein is omitted for sake of brevity. The system 700 can include digital signal processing 702 that employs accelerometer data 704 to identify a primary abuse event category 706 for an abuse event associated with an electronic device (e.g., the electronic device 302). The accelerometer data 704 can be generated by the one or more sensors 308, the abuse sensor 402, and/or the accelerometer sensor 405. The system 700 can also include a machine learning process 708 that employs inertial data 710, image data 712, audio data 714, device history data 716, and/or trend data 718 to identify a secondary abuse event category 720 for the abuse event associated with the electronic device (e.g., the electronic device 302). The inertial data 710 can be generated by the one or more sensors 308 and/or the inertial sensor 410, for example. Additionally, the image data 712 can be generated by the one or more sensors 308 and/or the image sensor 406. The audio data 714 can be generated, for example, by the microphone 408. The device history data 716 can be device data (e.g., historical device data) associated with the electronic device (e.g., the electronic device 302). The device history data 716 can also provide insight into user behavior associated with the electronic device (e.g., the electronic device 302). The trend data 718 can be associated with a time of day or a season of year for the abuse event, a type of customer segment for the electronic device (e.g., the electronic device 302), a user type associated with the electronic device (e.g., the electronic device 302), user trends associated with the electronic device (e.g., the electronic device 302), and/or other trend data associated with the abuse event.

The digital signal processing 702 can receive the accelerometer data 704 as input to facilitate determining the primary abuse event category 706. The digital signal processing 702 can employ one or more digital signal processing techniques to analyze the accelerometer data 704. In certain embodiments, the digital signal processing 702 can be related to a digital signal processor (e.g., the digital signal processor 310, the digital signal processor 404, etc.) to perform one or more signal processing operations with respect to the accelerometer data 704. In certain embodiments, the digital signal processing 702 can employ one or more digital signal processing techniques to analyze x-coordinate data, y-coordinate data and/or z-coordinate data of the accelerometer data 704. In one example, the digital signal processing 702 can determine whether a certain accelerometer value (e.g., √(x²+y²+z²) where x corresponds to the x-coordinate data, y corresponds to the y-coordinate data, and z corresponds to the z-coordinate data) is greater than a defined value (e.g., 5 g where g is the acceleration of gravity value). In such a scenario, the digital signal processing 702 can determine, for example, that the primary abuse event category 706 corresponds to a hit event for the electronic device 302. In another example, the digital signal processing 702 can determine an interval of time that the certain accelerometer value (e.g., √(x²+y²+z²)) is above the defined value. For example, the digital signal processing 702 can determine that the primary abuse event category 706 corresponds to a throw event for the electronic device 302 in response to a determination that the certain accelerometer value (e.g., √(x²+y²+z²)) is above the defined value for a certain interval of time (e.g., 0.4 seconds, etc.).

In an embodiment, the machine learning process 708 can employ one or more machine learning process and/or one or more artificial intelligence techniques to determine the secondary abuse event category 720. For example, the machine learning process 708 can perform learning (e.g., deep learning, etc.) with respect to the inertial data 710, the image data 712, and/or the audio data 714 to determine one or more classifications, one or more correlations, one or more expressions, one or more inferences, one or more patterns, one or more features and/or other learned information related to the inertial data 710, the image data 712, and/or the audio data 714. In an aspect, the machine learning process 708 can employ one or more machine learning process and/or one or more artificial intelligence techniques to determine the secondary abuse event category 720. The learning performed by the machine learning process 708 can be performed explicitly or implicitly with respect to the inertial data 710, the image data 712, and/or the audio data 714. In another aspect, the machine learning process 708 can employ a machine learning model (e.g., a classification model, a machine learning classifier, etc.) to determine one or more classifications, one or more correlations, one or more expressions, one or more inferences, one or more patterns, one or more features and/or other learned information related to the inertial data 710, the image data 712, and/or the audio data 714. In an example, the machine learning model (e.g., a classification model, a machine learning classifier, etc.) employed by the machine learning process 708 can utilize one or more inference-based schemes to determine one or more classifications, one or more correlations, one or more expressions, one or more inferences, one or more patterns, one or more features and/or other learned information related to the inertial data 710, the image data 712, and/or the audio data 714. In an aspect, the inertial data 710, the image data 712, and/or the audio data 714 can be provided as input to the machine learning process 708 to facilitate the or more machine learning process and/or the one or more artificial intelligence techniques to determine the secondary abuse event category 720. Furthermore, output of the machine learning process 708 can be, for example, the secondary abuse event category 720 and/or a prediction for the secondary abuse event category 720.

In one embodiment, the machine learning process 708 can employ a SVM classifier to determine one or more classifications, one or more correlations, one or more expressions, one or more inferences, one or more patterns, one or more features and/or other learned information related to the inertial data 710, the image data 712, and/or the audio data 714. In another embodiment, the machine learning process 708 can employ one or more machine learning classification techniques associated with a Bayesian machine learning network, a binary classification model, a multiclass classification model, a linear classifier model, a quadratic classifier model, a neural network model, a probabilistic classification model, decision trees and/or one or more other classification models. Furthermore, in certain embodiments, the machine learning process 708 can be explicitly trained (e.g., via training data) and/or implicitly trained (e.g., via extrinsic data received by the machine learning process 708). In an embodiment, the secondary abuse event category 706 can correspond to an abuse event for the electronic device 302, an event related to throwing the electronic device 302 on the ground at a near distance, an event related to throwing the electronic device 302 on the ground at a far distance, an event related to throwing the electronic device 302 upwards and allowing the electronic device to subsequently free fall, an event related to dropping the electronic device 302 on a soft surface, an event related to dropping the electronic device 302 on a hard surface, or another potential event that can cause damage to the electronic device 302. Furthermore, the secondary abuse event category can indicate that the electronic device 302 is not related to a hit event, a drop event or a throw event.

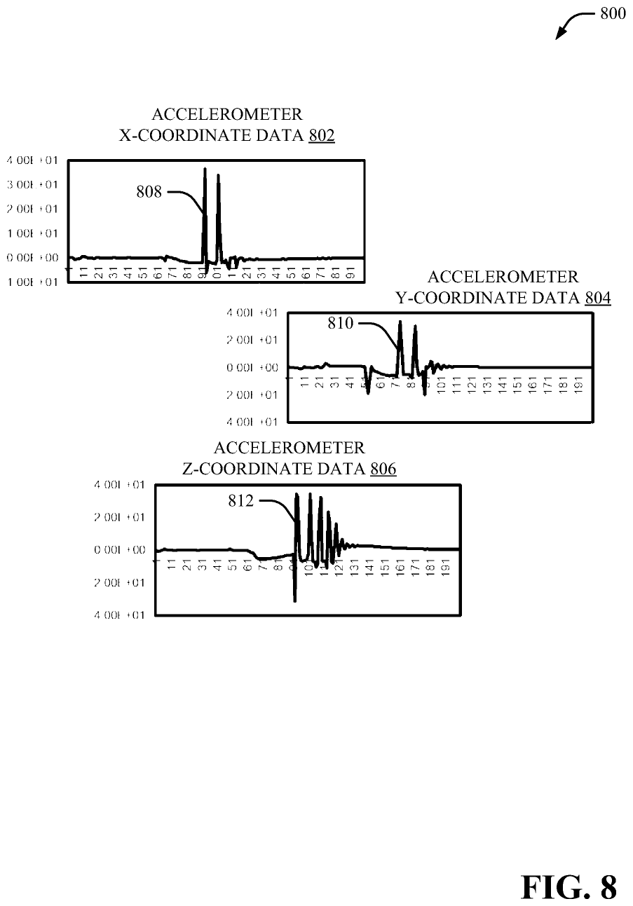

FIG. 8 illustrates a system 800 in accordance with one or more embodiments of the disclosure can be implemented. Repetitive description of like elements described in other embodiments herein is omitted for sake of brevity. The system 800 can include accelerometer x-coordinate data 802, accelerometer y-coordinate data 804 and/or accelerometer z-coordinate data 806. The accelerometer x-coordinate data 802, the accelerometer y-coordinate data 804 and/or the accelerometer z-coordinate data 806 can be generated by the one or more sensors 308, the abuse sensor 402, and/or the accelerometer sensor 405. In an embodiment, the primary abuse event component 104 can identify the primary abuse event category associated with the electronic device based on a first comparison between a first defined accelerometer threshold value and the accelerometer x-coordinate data 802, a second comparison between a second defined accelerometer threshold value and the accelerometer y-coordinate data 804, and a third comparison between a third defined accelerometer threshold value and the accelerometer z-coordinate data 806. In another embodiment, the primary abuse event component 104 can employ a time-based digital signal processing algorithm to analyze the accelerometer x-coordinate data 802, the accelerometer y-coordinate data 804 and/or the accelerometer z-coordinate data 806. For example, the primary abuse event component 104 can identify one or more patterns in the accelerometer x-coordinate data 802, the accelerometer y-coordinate data 804 and/or the accelerometer z-coordinate data 806. For example, the accelerometer x-coordinate data 802 can include a pattern 808 that satisfies a defined abuse event criterion associated with a first defined accelerometer threshold value, the accelerometer y-coordinate data 804 can include a pattern 810 that satisfies a defined abuse event criterion associated with a second defined accelerometer threshold value, and/or the accelerometer z-coordinate data 806 can include a pattern 812 that satisfies a defined abuse event criterion associated with a third defined accelerometer threshold value.

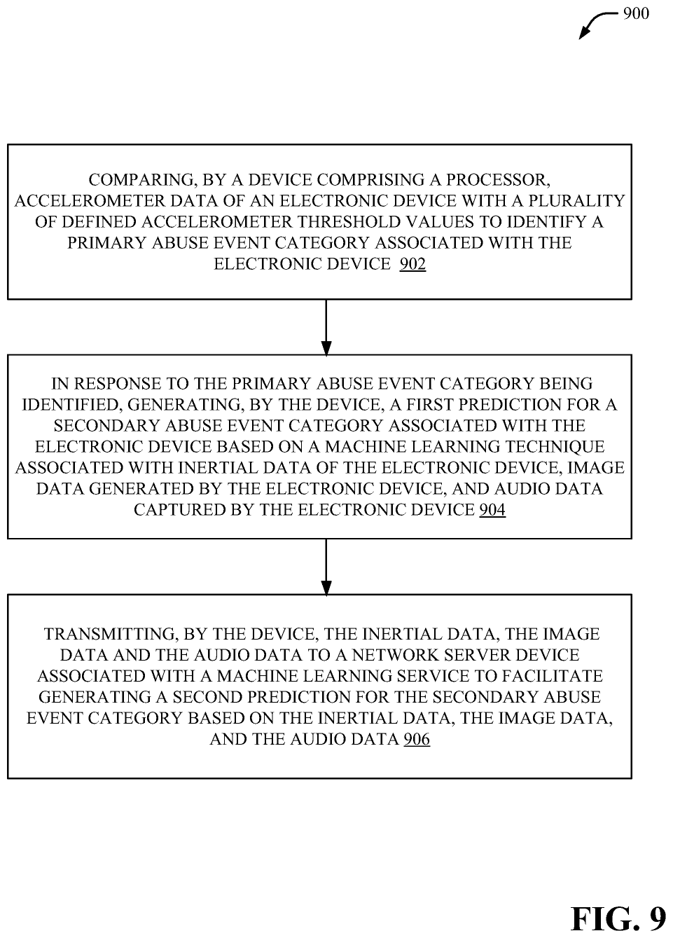

FIG. 9 illustrates a computer-implemented method 900 for facilitating device abuse detection using machine learning, in accordance with one or more embodiments described herein. Repetitive description of like elements described in other embodiments herein is omitted for sake of brevity. The computer-implemented method 900 can be associated with the device abuse detection system 102, for example. In one or more embodiments, the computer-implemented method 900 begins with comparing, by a device comprising a processor, accelerometer data of an electronic device with a plurality of defined accelerometer threshold values to identify a primary abuse event category associated with the electronic device (block 902). The computer-implemented method 900 further includes, in response to the primary abuse event category being identified, generating, by the device, a first prediction for a secondary abuse event category associated with the electronic device based on a machine learning technique associated with inertial data of the electronic device, image data generated by the electronic device, and audio data captured by the electronic device (block 904). Furthermore, the computer-implemented method 900 includes transmitting, by the device, the inertial data, the image data and the audio data to a network server device associated with a machine learning service to facilitate generating a second prediction for the secondary abuse event category based on the inertial data, the image data, and the audio data (block 906). In certain embodiments, the computer-implemented method 900 can further include generating, by the device, the first prediction for the secondary abuse event category based on a machine learning model received from the network server device associated with the machine learning service. Additionally, in certain embodiments, the computer-implemented method 900 can further include receiving, by the device, a notification that is generated based on the first prediction for the secondary abuse event category and the second prediction for the secondary abuse event category.

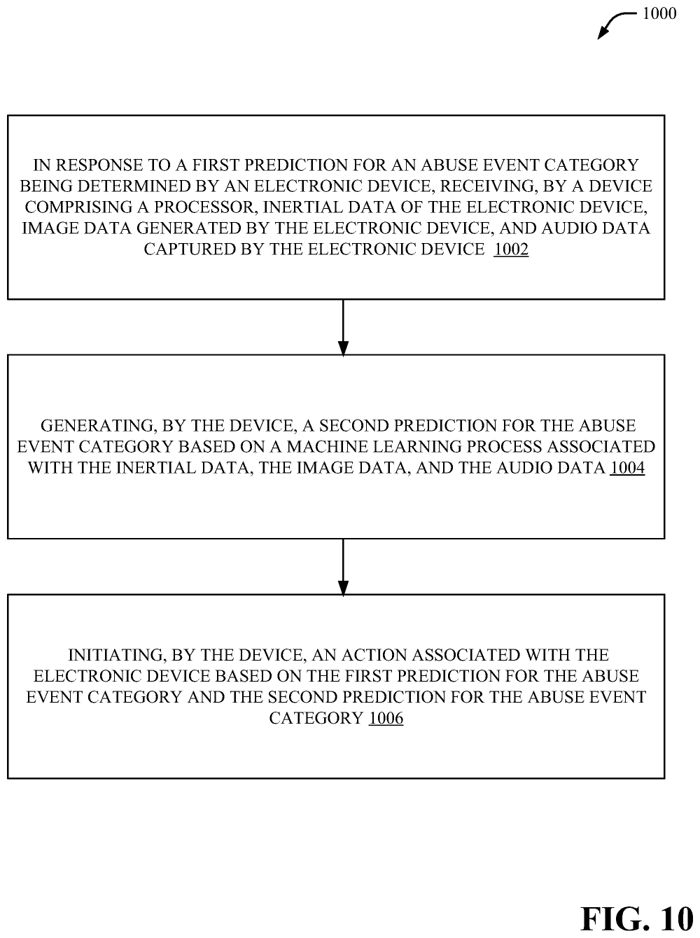

FIG. 10 illustrates a computer-implemented method 1000 for facilitating device abuse detection using machine learning, in accordance with one or more embodiments described herein. Repetitive description of like elements described in other embodiments herein is omitted for sake of brevity. The computer-implemented method 1000 can be associated with the cloud machine learning system 202, for example. In one or more embodiments, the computer-implemented method 1000 begins with, in response to a first prediction for an abuse event category being determined by an electronic device, receiving, by a device comprising a processor, inertial data of the electronic device, image data generated by the electronic device, and audio data captured by the electronic device (block 1002). The computer-implemented method 1000 further includes generating, by the device, a second prediction for the abuse event category based on a machine learning process associated with the inertial data, the image data, and the audio data (block 1004). Furthermore, the computer-implemented method 1000 includes initiating, by the device, an action associated with the electronic device based on the first prediction for the abuse event category and the second prediction for the abuse event category.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The hardware used to implement the various illustrative logics, logical blocks, modules, and circuits described in connection with the aspects disclosed herein may include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor may be a microprocessor, but, in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods may be performed by circuitry that is specific to a given function.

In one or more example embodiments, the functions described herein may be implemented by special-purpose hardware or a combination of hardware programmed by firmware or other software. In implementations relying on firmware or other software, the functions may be performed as a result of execution of one or more instructions stored on one or more non-transitory computer-readable media and/or one or more non-transitory processor-readable media. These instructions may be embodied by one or more processor-executable software modules that reside on the one or more non-transitory computer-readable or processor-readable storage media. Non-transitory computer-readable or processor-readable storage media may in this regard comprise any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media may be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

What is claimed is:

1. A system, comprising:
a processor; and
a memory that stores executable instructions that, when executed by the processor, cause the processor to:
compare accelerometer data of an electronic device with a plurality of defined accelerometer threshold values to identify a primary abuse event category associated with the electronic device;
in response to the primary abuse event category being identified, generate a first prediction for a secondary abuse event category associated with the electronic device based on a machine learning technique associated with inertial data of the electronic device, image data generated by the electronic device, and audio data captured by the electronic device; and
transmit the inertial data, the image data and the audio data to a network server device associated with a machine learning service to facilitate generation of a second prediction for the secondary abuse event category based on the inertial data, the image data, and the audio data.

2. The system of claim 1, wherein the executable instructions further cause the processor to:
receive the accelerometer data from an accelerometer sensor of the electronic device.

3. The system of claim 1, wherein the executable instructions further cause the processor to:
identify the primary abuse event category associated with the electronic device based on a first comparison between a first defined accelerometer threshold value and first accelerometer data associated with an x-coordinate of an accelerometer sensor of the electronic device, a second comparison between a second defined accelerometer threshold value and second accelerometer data associated with a y-coordinate of the accelerometer sensor, and a third comparison between a third defined accelerometer threshold value and third accelerometer data associated with a z-coordinate of the accelerometer sensor.

4. The system of claim 1, wherein the executable instructions further cause the processor to:
identify the primary abuse event category as a potential hit event associated with the electronic device in response to a determination that the accelerometer data satisfies a defined sensor value.

5. The system of claim 1, wherein the executable instructions further cause the processor to:
identify the primary abuse event category as a potential throw event associated with the electronic device in response to a determination that the accelerometer data is above a defined sensor value for a certain interval of time.

6. The system of claim 1, wherein the executable instructions further cause the processor to:
identify a particular type of abuse event associated with the electronic device based on the machine learning technique associated with the inertial data, the image data, and the audio data.

7. The system of claim 1, wherein the executable instructions further cause the processor to:
identify a particular type of throw event associated with the electronic device based on the machine learning technique associated with the inertial data, the image data, and the audio data.

8. The system of claim 1, wherein the executable instructions further cause the processor to:
generate the first prediction for the secondary abuse event category based on a machine learning model received from the network server device associated with the machine learning service.

9. The system of claim 1, wherein the executable instructions further cause the processor to:
receive, from the network server device, a notification that is generated based on the first prediction for the secondary abuse event category and the second prediction for the secondary abuse event category.

10. A system, comprising:
a processor; and
a memory that stores executable instructions that, when executed by the processor, cause the processor to:
in response to a first prediction for an abuse event category being determined by an electronic device, receive inertial data of the electronic device, image data generated by the electronic device, and audio data captured by the electronic device;
generate a second prediction for the abuse event category based on a machine learning process associated with the inertial data, the image data, and the audio data; and
initiate an action associated with the electronic device based on the first prediction for the abuse event category and the second prediction for the abuse event category.

11. The system of claim 10, wherein the executable instructions further cause the processor to:
train a classification model for the abuse event category based on the inertial data, the image data, and the audio data.

12. The system of claim 10, wherein the executable instructions further cause the processor to:
transmit, to the electronic device, a retrained version of a classification model for the abuse event category, wherein the classification model is retrained based on the inertial data, the image data, and the audio data.

13. The system of claim 10, wherein the executable instructions further cause the processor to:
receive data from one or more other electronic devices; and
train a classification model for the abuse event category based on the inertial data, the image data, the audio data, and the data associated with the one or more other electronic devices.

14. The system of claim 10, wherein the executable instructions further cause the processor to:
initiate an action associated with the electronic device based on device history data associated with the electronic device.

15. The system of claim 10, wherein the executable instructions further cause the processor to:
initiate an action associated with the electronic device based on trend data associated with a time of day or a season of year.

16. The system of claim 10, wherein the executable instructions further cause the processor to:
initiate an action associated with the electronic device based on trend data associated with a type of customer segment for the electronic device.

17. The system of claim 10, wherein the executable instructions further cause the processor to:
initiate an action associated with the electronic device based on trend data associated with a user type associated with the electronic device.

18. A computer-implemented method, comprising:
comparing, by a device comprising a processor, accelerometer data of an electronic device with a plurality of defined accelerometer threshold values to identify a primary abuse event category associated with the electronic device;
in response to the primary abuse event category being identified, generating, by the device, a first prediction for a secondary abuse event category associated with the electronic device based on a machine learning technique associated with inertial data of the electronic device, image data generated by the electronic device, and audio data captured by the electronic device; and
transmitting, by the device, the inertial data, the image data and the audio data to a network server device associated with a machine learning service to facilitate generating a second prediction for the secondary abuse event category based on the inertial data, the image data, and the audio data.

19. The computer-implemented method of claim 18, further comprising:
generating, by the device, the first prediction for the secondary abuse event category based on a machine learning model received from the network server device associated with the machine learning service.

20. The computer-implemented method of claim 18, further comprising:
receiving, by the device, a notification that is generated based on the first prediction for the secondary abuse event category and the second prediction for the secondary abuse event category.
